(19) United States
(12) Patent Application Publication
(10) Pub. No.: US 2007/0104145 A1
(43) Pub. Date: May 10, 2007

(54) Data accessing method for a wireless communication device performing a handover operation between wireless stations

(76) Inventor: Hsiao-Shun Jan, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/268,454

(22) Filed: Nov. 8, 2005

(51) Int. Cl. H04Q 7/00

(52) U.S. Cl. 370/331; 455/436; 370/395.4

(57) ABSTRACT

A data accessing method for performing a handover operation between wireless communication stations is provided. In particular, the present invention provides a virtual DHCP server module that is installed in a wireless communication device and roams between a plurality of wireless stations. Wherein, a communication module, which can simultaneously record a plurality of network addresses and their related domain information, is introduced into the wireless communication device. Through a NAT means, the device can perform handover operations between those wireless stations and achieve seamless communication there between. The data access method thereof comprises a step of simultaneously establishing a plurality of links to the plurality of wireless stations, then a power-saving mode signal and a wake-up mode signal are transmitted between the stations thereby, and a step of transferring and receiving data in the communication module using the NAT means to transform a private addresses to public addresses.

### BACKGROUND OF THE INVENTION

1. Field of the Invention

The present invention relates to a data accessing method for a wireless communication device performing handover operations between wireless stations, and more particularly to the wireless communication device having a communication module therein, which can simultaneously record a plurality of sets of domain information so as to achieve seamless, uninterrupted communication.

2. Description of Related Art

When a terminal device moves from a network segment to the coverage of another network segment, and establishes a link to the next segment, the terminal device needs to be reconfigured in response to the network address of the next segment and the related domain information. In the intervening time, the data transmission will suffer a short interruption. The interruption is not usually obvious to users as the data to be transferred is a common data packet, but it's a serious issue as the data to be transferred is a real-time voice packet. The interruption affects the communication since the voice packet requires real-time transmission.

In addition to having a stable transmission of the mobile communication employing a wireless network such as WLAN, Wimax or the like, the wireless signal shall be received while roaming between two network segments in order to achieve seamless communication.

U.S. Patent Publication No. 2004/0121772 discloses a method for supporting mobility of a WLAN voice terminal, wherein two access points are used to process signals of a terminal device performing a handover operation there between. The terminal device continuously detects the wireless signal nearby as it processes voice messaging. When the terminal device roams between two wireless access points, the method performs a handover operation by using terminal information of the terminal device and MAC address information of a first access point upon the re-association request of the terminal device through a second access point.

Reference is made to FIG. 1 illustrating voice transmission over IP in the wireless telecommunications system of U.S. Patent Publication No. 2004/0203785. A wireless terminal device 10, such as a mobile phone, performs a wireless-network based voice communication (voice over IP), and roams between the widespread stations 101, 102 and 103. Each station 101, 102 and 103 of an embodiment connects to different gateways 104, 105 and 106 respectively. Whereby, the device 10 proceeds to transfer and transform the voice packets, for example, compressing or decompressing the packets. Moreover, each gate 104, 105 and 106 connects to the controllers 107, 108 and 109 respectively so as to control the transmission width and process signals. When the wireless terminal device 10 performs a handover operation between the two stations, the corresponding controllers transmit messages to each other, then the device 10 can connect to the next wireless station more smoothly.

The above-mentioned skill provides a method to solve the problem of continuously signaling while performing a handover operation between stations when the terminal device processes the voice communication. Nevertheless, since the signal to be interrupted is unavoidable during a handover operation in signaling, the structure of the wireless communication needs to be changed to overcome the re-transmission issue.

### SUMMARY OF THE DISCLOSURE

For overcoming the re-transmission issue suffered in the prior art, the present invention provides a terminal device having a virtual DHCP (Dynamic Host Configuration Protocol) server module, and a communication module, which simultaneously has a plurality of information about domains including their network addresses and related information. Furthermore, a NAT means, which attempts to transform a public domain to a private domain, is incorporated to achieve seamless communication as the wireless terminal device performs a handover operation between stations.

The method for performing a handover operation between a plurality of wireless stations used for a wireless communication device of the present invention comprises a first step of searching for an available wireless network signal; establishing a first link between the wireless communication device and a first wireless station; requesting a first network address and its related domain information; then, after transmitting a first power-saving mode signal to the first wireless station, searching for a wireless network signal; transmitting a wake-up mode signal to the first wireless station so as to transfer data there between; and finally, after detecting a roaming event, transmitting the power-saving mode signal to the first wireless station so as to establish a second link between the wireless communication device and a second wireless station and request a second network address and its related domain information in the meanwhile.

Moreover, the communication device transmits a power-saving mode signal to the second wireless station. After transmitting the wake-up mode signal to the first wireless station and transferring data, a link is established. If a second link is required, the communication device transmits a wake-up mode signal to the second wireless station, and proceeding to transfer data.

The present invention provides a data accessing method for a wireless communication device performing a handover operation between a plurality of wireless stations, wherein the wireless communication device roams between the stations and achieves seamless communication there between through a NAT means, the method for performing handover operation comprises a step of requesting a virtual network address, and searching for a wireless network signal in the beginning. Then a first link is established for obtaining a first network address and its related domain information, and transforming the virtual network address and the first network address, thereby the network address translation (NAT) means is used to transfer or receive data. In the meantime, the communication searches for another wireless network signal so as to establish a second link. Then, a second network address and its related domain information is obtained. During the period of establishing a linking status, a roaming event is detected, then the virtual network address and the second network address are transformed by the NAT means used for transferring or receiving data.

### BRIEF DESCRIPTION OF DRAWINGS

The present invention will be readily understood by the following detailed description in conjunction with accompanying drawings, in which:

FIG. 1 is a schematic diagram for signal transmission of the wireless communication device of the prior art;

FIG. 2A is a schematic diagram of the structure of the network communication protocol in the prior art;

FIG. 2B is a schematic diagram of a virtual network communication structure of the wireless communication device of the present invention;

FIG. 3A shows a roaming diagram of a wireless communication device;

FIG. 3B shows a timing diagram as a DHCP client module of the present invention requests a network address;

FIG. 4 shows a flowchart illustrating the connection establishment of a wireless communication device and the wireless stations;

FIG. 5 is a flowchart for the data transferring of the wireless communication device of the embodiment; and

FIG. 6 is a schematic diagram of the structure for data transferring of the present invention.

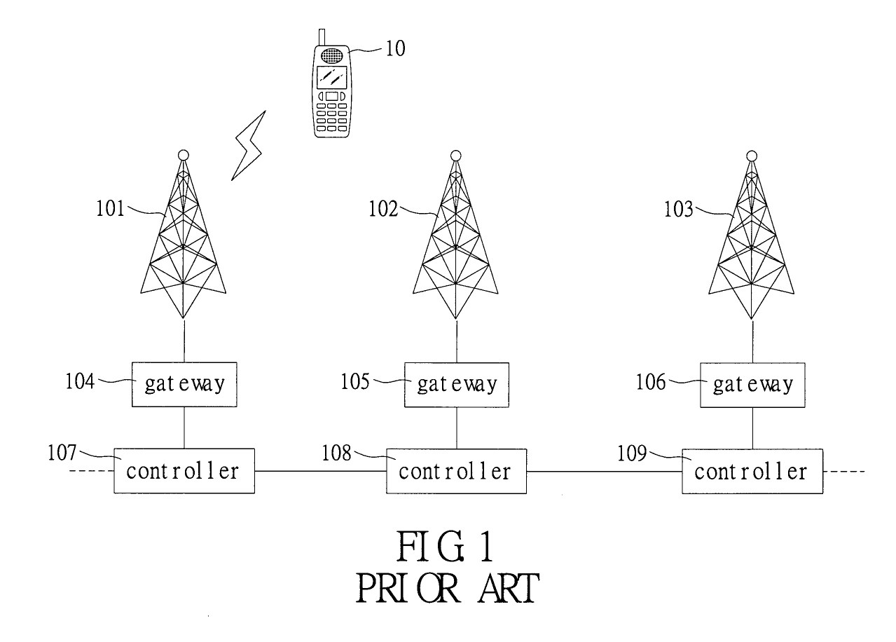

### DETAILED DESCRIPTION OF THE PREFERRED EMBODIMENTS

To understand the technology, means and functions adopted in the present invention further, reference is made to the following detailed description and attached drawings. The invention shall be readily understood deeply and concretely from the purpose, characteristics and specifications. Nevertheless, the present invention is not limited to the attached drawings and embodiments in following description.

The preferred embodiment of the present invention provides a wireless communication device based on VoIP (Voice over IP) technology. The network modules is a built-in wireless communication device, such as a DHCP (Dynamic Host Configuration Protocol) client module, which is used to request a network address in a specific domain and its related information from a DHCP server in a certain wireless station. The domain information includes a gateway host, a DNS (Domain Name Server), a broadcast address, a net mask or the like.

The data accessing method when performing a handover operation of the present invention comprises the step of simultaneously establishing a plurality of links to the plurality of wireless stations. Particularly, a power-saving mode signal and a wake-up mode signal are used to control data transfer between the stations. Moreover, a NAT (Network Address Translation) means is introduced to employ the address transformation between a virtual network address and a public network address saved in the wireless module so as to transfer data.

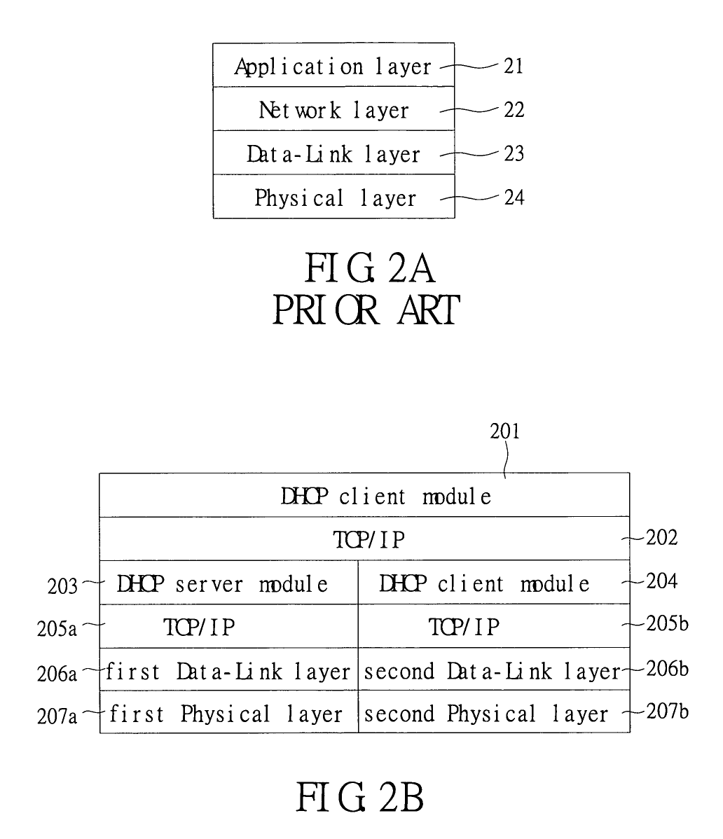

FIG. 2A shows a conventional structure of the network communication protocol. In the application of the network structure, both a server end and a client end have an Application layer 21, which provides services to an application program; a Network layer 22, which provides the protocol and procedural means of transferring variable length data, such as TCP/IP that is often used in a network; a Data-link layer 23, which defines two different network systems and provides the functional and procedural means to transfer data between network entities; and a Physical layer 24, which is the network entities used for transferring and receiving data. The Network layer 22 determines routing of packets of data from sender to receiver via the Data-link layer 23, where the data packet is converted into a series of smaller packets to the Physical layer 24 for physical bit transferring. The above-mentioned Physical layer 24 uses a MAC address linking both the server end and the client end so as to implement the packet transferring.

Reference is made to FIG. 2B, which shows a network module built-in the wireless communication device provided by the present invention. A network module includes a DHCP client module 201, which is used to receive a network address and its related domain information allocated by a DHCP server. Wherein, the network layer provides a network protocol, i.e. TCP/IP (202). Without any influence upon the configuration of the server end and the network standard, the mentioned network module provided by the present invention can simultaneously handle different domain information, wherein the network address, such as an IP address, is used to link to a server that only allocates the network address.

In this embodiment, the wireless communication device, such as a VoIP mobile phone, has a virtual DHCP server module built-in the network module therein. The virtual DHCP server module is simulated by software, and can simultaneously have a plurality of network addresses, such as an IP address, and their related domain information. Since the network module is required to handle the plurality of network addresses at the same time, a firmware or software is utilized to simulate two groups of network communication protocol structure. For example, FIG. 2B shows a preferred embodiment of the present invention comprising a first TCP/IP network layer 205a of the DHCP server module 203, a first data-link layer 206 and a first physical layer 207a the network module simulates. Likewise, the network module has a DHCP client module 204 built-in the wireless communication device, a second TCP/IP network layer 205b, a second data-link layer 206b, and a second physical layer 207b.

The present invention proposes a mobile communication based on a wireless network. The DHCP client module 201 built-in the wireless communication device requests a network address and its domain information from the DHCP server module 203, which is the firmware or is simulated by software. Since the above-mentioned network address is a private network address, the network module in the wireless communication device doesn't frequently change its network address with its related domain information as it is roaming between different domains. However, a public network address allotted from the wireless station is thus received by the simulated DHCP server module 203 in the device. Wherein, the NAT means is utilized to transform the public network address to the fixed private network address, so the network module won't cause delays or interruptions as it is transforming the network address.

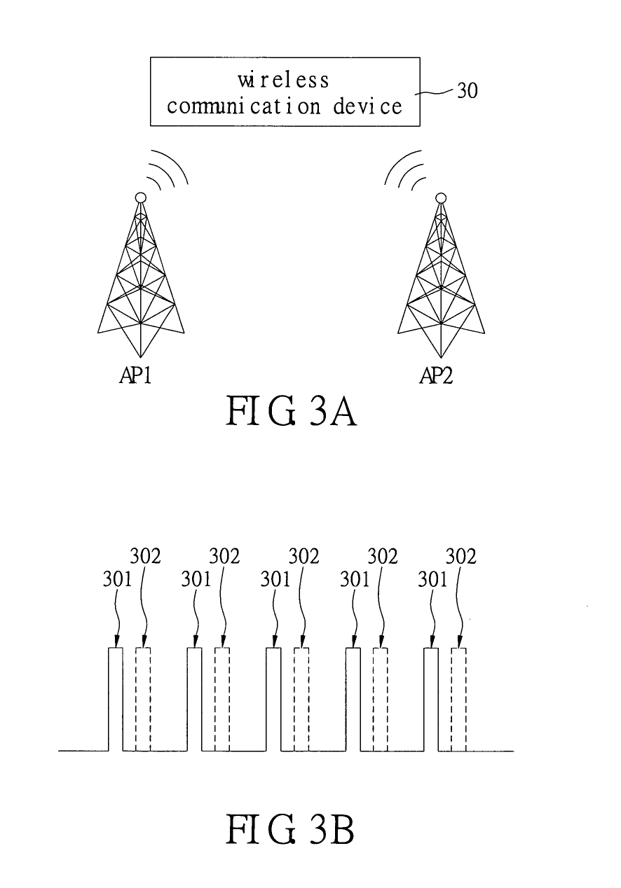

FIG. 3A shows a diagram of the wireless communication device in roaming status. The wireless communication device 30 operates between a first wireless station AP1 and a second wireless station AP2, wherein, the network module therein determines which wireless station is linked to the communication device 30 by detecting the intensity while signaling. When the two wireless stations perform the handover operation, the simulated virtual DHCP client module built-in the network module receives a network address and its related domain information allocated from the DHCP server module, which links to the wireless station. The simulated DHCP client module can simultaneously handle a plurality of allocated network addresses, such as two groups, while performing the handover operation. Thereby seamless communication is reached by the NAT means of the present invention.

FIG. 3B shows a timing signal as the DHCP client module requests information from the domain information. The network module transmits a signal, such as a power-saving mode signal 301, to the linked wireless station periodically. The power-saving mode signal 301 is directed to the power management, which is one of the wireless communication protocols defined by IEEE 802.11. The wireless communication device or the wireless station can suitably adjust the power management state, such as to power-saving mode or active mode, according to its power consumption or communication condition, so the communication device can thereby reduce its power consumption.

The period in which the wireless communication device transmits the power-saving mode signal 301 to the wireless station is the active mode period of the network module. In active mode, the wireless communication device can transmit or receive data. The wireless communication device utilizes the power-saving mode signal 301 to transmit a request signal 302 to the wireless station periodically, that is, the wireless communication device requests a network address (IP address) and its domain information of the domain it belongs to from a DHCP server, and searches for another available wireless signal in the mean time.

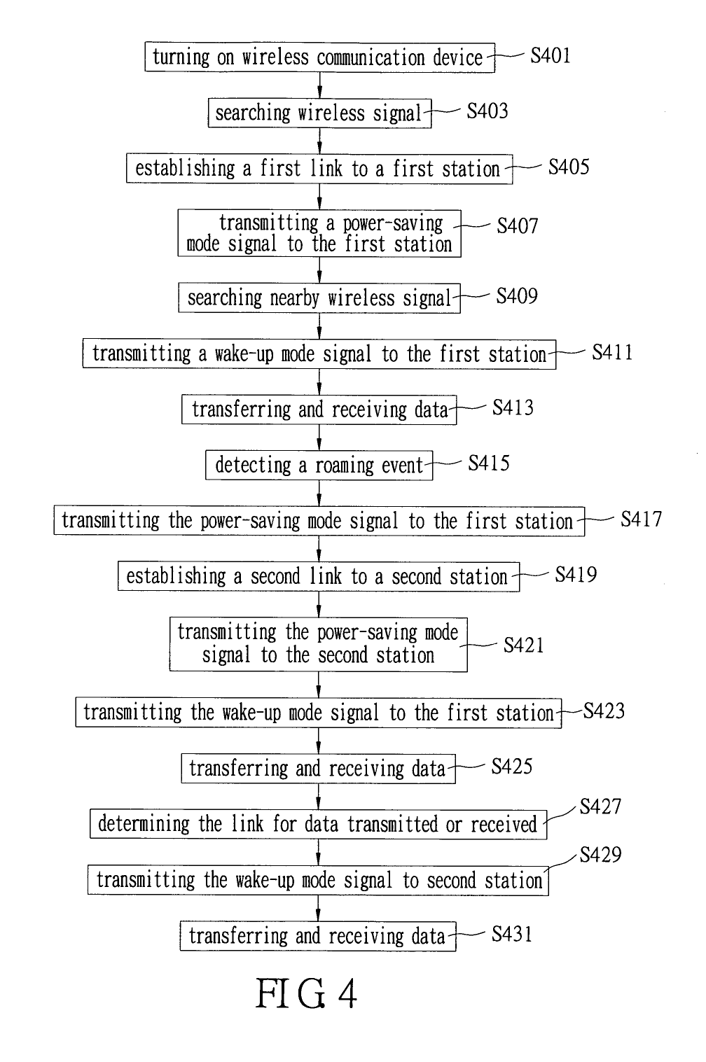

Reference is made to FIG. 4 showing a flowchart for the connection of the wireless communication device and the wireless station.

In the beginning, a wireless communication device is turned on, a VoIP mobile phone or the wireless device with wireless network communication is the preferred embodiment (step S401). As in step S403, a network module built-in the wireless communication device searches for an available wireless signal. In the preferred embodiment, the network module scans and detects the wireless network signal, and performs authentication, registering, linking quality checking or/and the like afterwards. After receiving the response from the wireless station, the wireless communication device establishes a first link to a first wireless station in step S405. In the meantime, the communication device requests a first network address (IP1). The step of linking to the first wireless station can further include a process for security and identification authentication, or perform a three-way handshake connection, such as a SYN-SYN-ACK signaling.

After establishing the first link, the wireless communication device transmits a first power-saving mode signal to the first wireless station. Since the first wireless station has received the first power-saving mode signal, the station suspends the connection to the wireless communication device (step S407). In the meanwhile, the wireless communication device searches for a nearby wireless signal (step S409).

Next, the wireless communication device further transmits a first wake-up mode signal to the first wireless station (step S411) so as to transmit and receive data (step S413). In the preferred embodiment of the present invention, the process for transmitting and receiving the network voice packets can be a regular process for transmitting and receiving data. In the period of voice transmission or data transmission, if the wireless communication device moves to the signaling range of a second wireless station, a possible roaming event can be detected (step S415). Next, the network module of the wireless communication device transmits the first power-saving mode signal to the first wireless station the device links to (step S417), and requests connection suspension. In the meantime, the wireless communication device establishes a second link to the second wireless station (step S419), and requests a second network address (IP2). Consequently, the wireless communication device provided by the present invention simultaneously handles two groups or more network addresses and their related domain information.

Next, the wireless communication device transmits a second power-saving mode signal to the second wireless station (step S421), and transmits the first wake-up mode signal to the first wireless station (step S423). In the preferred embodiment, the wireless communication device maintains the first link and the second link simultaneously, and the first link is used for transferring and receiving data, such as a voice packet (step S425). Since the wireless communication device is in roaming status between the wireless stations, the link for transmitting or receiving data is determined in the power-saving mode (step S427). A radio signal strength indicator (RSSI) is introduced to detect the intensity of the wireless network signal of the preferred embodiment, and thereby determines whether the first link is suspended and the second link is used for transmission, or if the second link is suspended and the first link is used for data transmission. If the first link needs to suspend or stop the transmission, the wireless communication device will transmit the second wake-up mode signal to the second wireless station (step S429) to process the transmitting and receiving data (step S431).

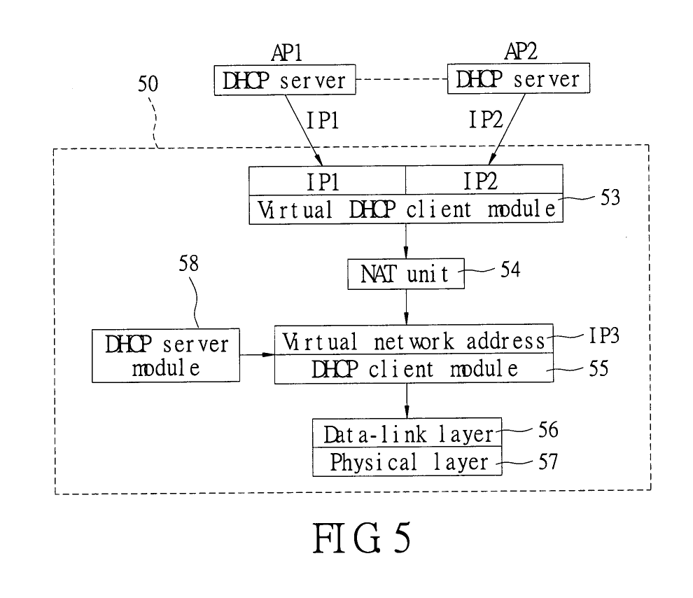

In view of the above-depicted steps comprising the step of searching the wireless signal, the step of linking the wireless stations and the step of determining the connection status, reference is made to FIG. 5 showing a data accessing method of the present invention. Whereby, the wireless communication device can roam around the wireless stations and process a seamless stations switching and data accessing.

In the schematic diagram shown in FIG. 5, the wireless communication device of the present invention can have two or more groups of the network addresses. The NAT means in the network module 50 is utilized to achieve the seamless transmission as the wireless communication device roams in each domain.

A virtual DHCP client module 53 of the network module 50 is simulated to have two or more network addresses and their related domain information. The first network address IP1 is allocated by linking to the first wireless station AP1 so as to establish the first link. Then the second network address IP2 allocated from the second wireless station AP2 is obtained, so as to establish the second link. Moreover, by detecting the connecting quality and the signaling intensity of the first link and the second link, the first link or the second link used for data transmission is determined.

Referring to FIG. 5, the first network address IP1 and the second network address IP2 are the public network addresses allocated from the wireless stations AP1 and AP2 respectively. In particular, each wireless station has different addresses for each network segment covered by each wireless station.

Furthermore, the original DHCP client module 55 in the network module 50 receives a virtual network address IP3 allocated from the virtual DHCP server module 58 therein. The virtual network address IP3 is the private network address defined by the network module 50, so the network module 50 doesn't need to change the network address frequently as a roaming events occur. After that, the NAT unit 54 therein transforms the first network address IP1 or the second network address IP2 allocated from the wireless stations to the private (virtual) network addresses IP3. Similarly, the NAT unit 54 is also used to transform the virtual network address to the first (IP1) or the second (IP2) network address.

Consequently, a data-link layer 56 and a physical layer 57 of the network module 50 are used to receive or transmit data via the NAT means, then, the network module 50 won't suffer errors or delays in response to the network configuration changing as it is in roaming status.

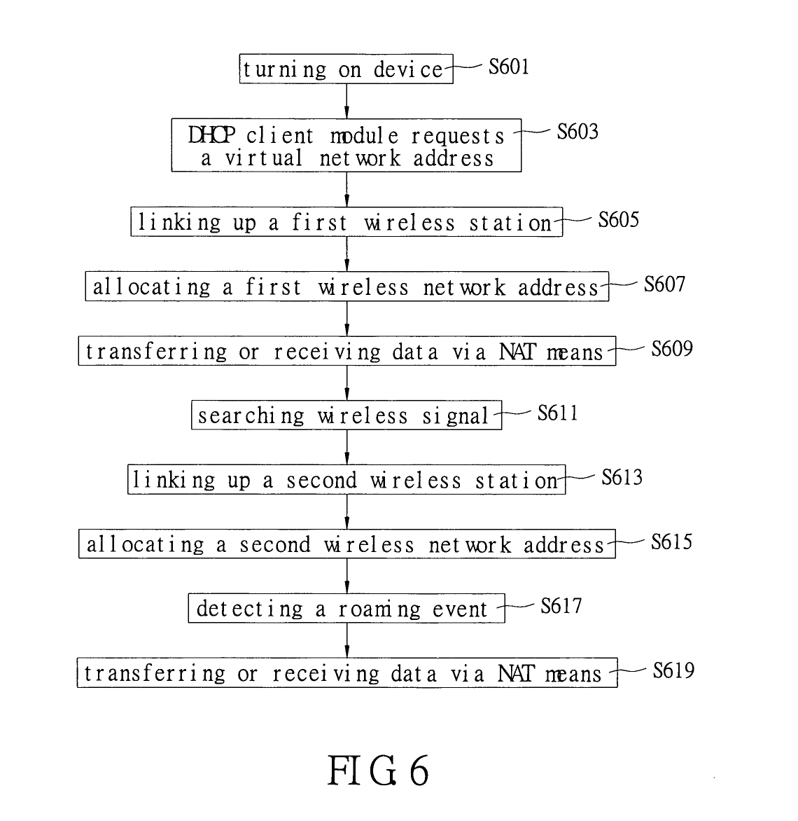

Reference is made to FIG. 6 (that also relates to the wireless communication device as shown in FIG. 5) that shows a flowchart of the wireless communication device in transmitting mode.

To begin, the wireless communication device is turned on (step S601), wherein the DHCP client module requests the built-in virtual DHCP server module simulated by firmware or software for a virtual network address (IP3) (step S603). In the meantime, a wireless signal is searched to establish a first link to the first wireless station (step S605). The first wireless station allocates a first network address (IP1) to the wireless communication device, and transfers the related domain information to the virtual DHCP client module thereof (step S607).

Next, the wireless communication device transfers or receives data via a NAT means (step S609). In the preferred embodiment, the NAT means is used to transform the first network address (IP1) and the virtual network address (IP3), and the physical network portion of the wireless communication device can then receive or transfer data. After that, an available wireless signal is searched for (step S611). Since another wireless signal has been searched for, such as the signal signaling from the second wireless station, the wireless communication device establishes a second link to perform a handover operation between the stations and take over the original linking manner (step S613). Then, the second wireless station allocates a second network address (IP2), and transmits its related domain information (steps S615).

Since the wireless communication device moves and detects a roaming event, the link is turned to second wireless station (step S617), meanwhile, the NAT means is used to transfer or receive data (step S619), and the link to the first wireless station (first link) is suspended. Then, the NAT means transforms the second network address (IP2) allocated from the second wireless station to the private virtual network address (IP3), and the physical network portion of the wireless communication device is used to receive or transfer data.

The present invention discloses a data accessing method for a wireless communication device performing a handover operation between wireless stations, wherein a virtual DHCP server module and a DHCP client module are simulated in the network module of a wireless communication device. Particularly, a NAT means is introduced so that the wireless communication device can roam between a plurality of wireless stations and achieve seamless communication.

The many features and advantages of the present invention are apparent from the written description above and it is intended by the appended claims to cover all. Furthermore, since numerous modifications and changes will readily occur to those skilled in the art, it is not desired to limit the invention to the exact construction and operation as illustrated and described. Hence, all suitable modifications and equivalents may be resorted to as falling within the scope of the invention.

What is claimed is:

1. A method for performing a handover operation between a plurality of wireless stations used by a wireless communication device, wherein the wireless communication device roams between the stations and performs the steps of the handover operation there between, the method for performing the handover operation comprising:
searching an available wireless network signal;
establishing a first link to a first wireless station;
requesting a first network address and its related domain information;
transmitting a first power-saving mode signal;
transmitting a first wake-up mode signal;
detecting a roaming event;
establishing a second link to a second wireless station;
requesting a second network address and its related domain information;
determining the linking status;
transmitting a second power-saving mode signal; and
transmitting a second wake-up mode signal.

2. The method as recited in claim 1, wherein the wireless stations includes a DHCP server.

3. The method as recited in claim 1, wherein the wireless communication device requests the wireless station for the network address and its related domain information.

4. The method as recited in claim 1, after the step of transmitting the power-saving mode signal to the wireless station, the step of searching the available wireless network signal is processed.

5. The method as recited in claim 1, after the step of transmitting the wake-up mode signal to the wireless station, a step of transferring data is processed.

6. The method as recited in claim 1, wherein the wireless communication device includes a DHCP client module.

7. The method as recited in claim 1, wherein the wireless communication device includes a virtual DHCP client module.

8. The method as recited in claim 7, wherein the virtual DHCP client module simultaneously handles a plurality of network addresses and their related domain information.

9. The method as recited in claim 1, wherein the step of establishing the link further includes a process of security and identification authentication.

10. The method as recited in claim 1, wherein the step of determining the linking status, a radio signal strength indicator (RSSI) is introduced to detect the intensity of signaling from the wireless stations.

11. A method for performing a handover operation between stations used for a wireless communication device, wherein the wireless communication device roams between the plurality of wireless stations, and performs a handover operation there between, the method for performing a handover operation between the stations comprises:
searching for an available wireless network signal;
establishing a first link, which establishes the link between the wireless communication device and a first wireless station;
requesting a first network address and its related domain information, that is requesting the domain information from the first wireless station;
transmitting a power-saving mode signal to the first wireless station, and proceeding to search the wireless network signal;
transmitting a wake-up mode signal to the first wireless station, and proceeding to transfer data;
detecting a roaming event;
transmitting the power-saving mode signal to the first wireless station;
establishing a second link, which establishes the link between the wireless communication device and a second wireless station;
requesting a second network address and its related domain information, that is requesting the domain information from the second wireless station;
transmitting the power-saving mode signal to the second wireless station;
transmitting the wake-up mode signal to the first wireless station, and proceeding to transfer data;
determining the linking status; and
transmitting the wake-up mode signal to the second wireless station, and proceeding to transfer data;
wherein, the wireless station includes a DHCP server, the wireless communication device includes a DHCP client module, a virtual DHCP client module, and a virtual DHCP server module, whereby, the wireless communication device performs the process of the handover operation between the stations and achieves seamless communication simultaneously through a NAT means.

12. The method as recited in claim 11, wherein the virtual DHCP client module has two or a plurality of network addresses and their related domain information.

13. The method as recited in claim 12, wherein the step of establishing the link includes a process of security and identification authentication.

14. The method as recited in claim 11, wherein the step of determining the linking status employs a radio signal strength indicator to detect the intensity of the signal from the wireless station.

15. A data accessing method for a wireless communication device performing a handover operation between a plurality of wireless stations, wherein the wireless communication device roams between the stations and achieves seamless communication there between through a NAT means, the method for performing the handover operation comprising:
requesting a virtual network address;
searching for a wireless network signal;
establishing a first link;
obtaining a first network address and its related domain information;
transforming the virtual network address and the first network address, thereby the network address translation (NAT) means is used to transfer or receive data;
searching for another wireless network signal;
establishing a second link;
obtaining a second network address and its related domain information;
determining a linking status, and detecting a roaming event; and
transforming the virtual network address and the second network address, thereby the NAT means is used to transfer or receive data;
wherein, the wireless stations includes a DHCP server, the wireless communication device has a DHCP client module, a virtual DHCP client module, and a virtual DHCP server module.

16. The method as recited in claim 15, wherein the network address and its domain information is obtained through a DHCP means.

17. The method as recited in claim 15, wherein the virtual DHCP client module simultaneously has a plurality of network addresses and their domain information.

18. The method as recited in claim 15, wherein the wireless communication device is a VoIP mobile phone.

19. The method as recited in claim 15, wherein the step of establishing the link includes a process of security and identification authentication.

20. The method as recited in claim 15, wherein the step of determining the linking status uses a radio signal strength indicator to detect the intensity of the signal from the wireless station.
